(19) United States
(12) Patent Application Publication
(10) Pub. No.: US 2010/0223740 A1
(43) Pub. Date: Sep. 9, 2010

(54) Motorcycle Ramp with Resting Platform

(76) Inventors: Michael J. Pratt, Draper, UT (US); David W. Bradley, Lehi, UT (US); Seth C. Lytle, American Fork, UT (US)

Correspondence Address: Michael F. Krieger;Kirton & McConkie, 60 East South Temple, Suite 1800, Salt Lake City, UT, 84111, US

(21) Appl. No.: 12/685,567

(22) Filed: Jan. 11, 2010

Related U.S. Application Data
(60) Provisional application No. 61/143,616, filed on Jan. 9, 2009.

(51) Int. Cl. B65G 69/30; E01D 18/00

(52) U.S. Cl. 14/69.5

(57) ABSTRACT

Motorcycle ramps that permit a single individual to safely and easily load a motorcycle to/from an elevated surface, such as a truck bed, without assistance of a second individual are described. The motorcycle ramp includes a fixed or moveable resting platform that receives and secures a rear wheel of the motorcycle, thereby preventing gravity from causing the motorcycle to roll uncontrolled down the ramp. When the rear wheel is resting on the platform, the person pushing the motorcycle up or down the ramp is more easily able to climb to and from the elevated surface, as the individual only needs to steady the motorcycle against sideways motion and needs not worry about backward motion down the ramp. The person is commonly able to prevent unwanted sideways motion using a single hand, freeing the person's other hand to assist in climbing up to or down from the elevated surface.

### CROSS-REFERENCE TO RELATED APPLICATIONS

This application claims the benefit of U.S. Provisional Application No. 61/143,616, filed Jan. 9, 2009.

### BACKGROUND OF THE INVENTION

1. Field of the Invention

The present invention relates to motorcycle ramps for loading and unloading a motorcycle onto/off of an elevated surface such as a truck bed, and more particularly to motorcycle ramps that permit a single person to load motorcycles onto an elevated surface without assistance or to unload motorcycles off of an elevated surface without assistance.

2. Background and Related Art

Many motorcycle users, especially users of dirt bikes, need to load or unload one or more motorcycles from an elevated surface. This is commonly needed, for example, with dirt bikes that may be transported from one location to another in a truck bed, trailer, or other carrier having an elevated surface. In some instances, the elevated surface (such as the truck bed) may be elevated multiple feet off the ground. In many instances, there is no way to decrease the vertical distance between the ground and the elevated surface, and the motorcycle must be somehow raised or lowered to and from the elevated surface.

One way that this has been achieved is by way of a motorcycle ramp, which commonly includes a substantially straight rise from the ground to the elevated surface, and possibly something to secure the ramp in place. Such ramps reduce the need to lift the motorcycle to and from the elevated surface, as the motorcycle can be rolled up and down the ramp. However, existing ramps have problems in their use, as they can be unsafe to use in some instances or require multiple people to load or unload the motorcycle safely.

Taking a pickup truck bed as an example, it can be extremely difficult for a single person to safely push a motorcycle up an existing ramp and into the truck bed. As the motorcycle is pushed up the ramp, the motorcycle handlebars often rise up to a height which may reach or exceed six feet (approximately two meters), depending on the height of the truck bed and the height of the handlebars. This height of the handlebars often occurs before the back wheel of the motorcycle reaches the top of the ramp, and the person pushing the motorcycle commonly discovers that he or she is unable to fully push the rear wheel of the motorcycle onto the truck bed while standing on the ground. Therefore, the person must try to hold the motorcycle against the forces of gravity tending to pull the motorcycle back and down the ramp as he or she simultaneously steadies the motorcycle from side-to-side and tries to climb up into the bed of the truck to continue pushing the motorcycle onto the truck bed. As may be appreciated, this maneuver is unsafe, and may lead to falls of the person and/or the motorcycle.

Several methods are commonly used to overcome these difficulties. One way commonly attempted to overcome this difficulty is for something to be used as a step that the person climbs as he or she pushes the motorcycle up the ramp in, hopefully, a single motion. This method is frequently difficult and may be disastrous, as the items used as the step are often improvised (such as a cooler) and may be prone to rolling or otherwise moving as the person tries to step up and push the motorcycle at the same time. Additionally, the person must commit to climbing up along the ramp in a single attempt, as it is commonly difficult to stand on the improvised step next to the motorcycle as gravity continues to pull the motorcycle downward and backward on the ramp.

Another way used to overcome this difficulty is to have a second person stand on the truck bed and take the motorcycle from the person down below as the motorcycle nears the top of the ramp. While functional and much safer, this method is not possible when a second individual is unavailable to assist with loading or unloading the motorcycle.

As another example of an attempt to overcome these difficulties, the motorcycle ramp may be manufactured of a width sufficient that the person can walk up with the motorcycle. While greatly improving safety and ease of loading the motorcycle, such ramps are typically much heavier (and thus more difficult to use and place), and are bulky for transportation and storage purposes. Therefore, such ramps have not typically found favor, and most ramps are not significantly wider than the width necessary to accommodate a single motorcycle tire.

As still another example of an attempt to overcome the difficulty of a single individual getting a motorcycle up a narrow ramp, some riders attempt to ride the motorcycle up the ramp. The primary difficulties with such methods are those of successfully navigating the ramp from bottom to top (and vice-versa) and stopping the motorcycle in time at the top of the truck bed. Such attempts result in many accidents and injuries, and are not to be recommended. It is simply too easy to fall off the side of the ramp, fail to have enough speed to reach the top of the ramp, or to have too much speed and be unable to stop the motorcycle within the short distance afforded by the pickup truck bed.

Therefore, for at least these reasons, existing ramps and other mechanisms for loading and unloading a motorcycle to and from an elevated surface such as a truck bed and the like have proved unsatisfactory.

### BRIEF SUMMARY OF THE INVENTION

Implementation of the present invention provides motorcycle ramps that permit a single individual to safely and easily load a motorcycle onto an elevated surface and to safely and easily unload the motorcycle from the elevated surface without assistance of a second individual. The motorcycle ramp includes a structure that receives and secures a rear wheel of the motorcycle, thereby preventing gravity from causing the motorcycle to roll uncontrolled down the ramp. The structure serves as a resting platform for the rear wheel of the motorcycle as the motorcycle is moved up or down the ramp. When the rear wheel is secured by the structure or resting on the structure, the person pushing the motorcycle up or down the ramp is more easily able to climb to and from the elevated surface, as the individual only needs to steady the motorcycle against side-to-side motion and needs not worry about backward motion down the ramp. The person is commonly able to prevent unwanted side-to-side motion using a single hand, freeing the person's other hand to assist in climbing up to or down from the elevated surface.

The motorcycle ramps may be manufactured using a variety of materials and techniques, and may include foldable, telescopic or other elements to provide for compact storage and transportation of the motorcycle ramps. The structure that receives the rear wheel or resting platform is one of a variety of structures that can be adapted to the ramp. In some implementations, a fixed structure provides the resting platform, such as a jog in the ramp or an elevated or raised structure attached atop an otherwise substantially-linear ramp. In other implementations, a movable structure provides the resting platform, and the moveable structure may be spring-loaded or otherwise biased into a position to provide the resting platform. The movable structure can be automatically or manually selectively actuated to allow passage of the motorcycle front and/or rear wheel as desired.

Thus, some implementations of the invention provide a motorcycle ramp that permits a single individual to safely load and unload a motorcycle to and from an elevated surface. The motorcycle ramp of such implementations includes an upper end configured to attach to or rest on a portion of an elevated surface, a lower end configured to rest on a lower surface, and a motorcycle-bearing surface extending between the upper end and the lower end. The motorcycle ramp also includes a resting structure configured to receive a rear wheel of a motorcycle and prevent unwanted downward and rearward motion of the rear wheel along the motorcycle-bearing surface, the resting structure being located in between the upper end and the lower end.

In some implementations, the resting platform or structure is formed from a jog in the motorcycle-bearing surface, which may be continuous or discontinuous. If the motorcycle-bearing surface is discontinuous, the motorcycle-bearing surface may be formed from a plurality of struts extending between side rails of the motorcycle ramp. The motorcycle-bearing surface may include an upper ramp section and a lower ramp section. In implementations with a jog, the upper ramp section and the lower ramp section are not coplanar, although they may be parallel to each other. The motorcycle ramp may be foldable or may be separable or otherwise capable of disassembly into more than one piece.

In some implementations, the resting platform includes an elevated or raised structure that is elevated above the motorcycle-bearing surface. The elevated or raised surface may be stationary or movable.

In various implementations, the motorcycle ramp may have a length between approximately half the length of a motorcycle and approximately twice the length of the motorcycle. The distance between the upper end and the resting platform or other structure in such embodiments may range between approximately half the length of the motorcycle and approximately the length of the motorcycle. The distance between the lower end and the resting platform or other resting structure may be similar.

Further implementations provide a motorcycle ramp having an upper end configured to attach to or rest on a portion of an elevated surface, a lower end configured to rest on a lower surface, and a motorcycle-bearing surface extending between the upper end and the lower end. A resting platform extends between an upper ramp section of the motorcycle-bearing surface and a lower ramp section of the motorcycle-bearing surface at an angle wherein the resting platform slopes opposite a slope of the motorcycle-bearing surface when the ramp is extended between the lower surface and the elevated surface.

Further implementations provide a motorcycle ramp having an upper end configured to attach to or rest on a portion of an elevated surface, a lower end configured to rest on a lower surface, and a motorcycle-bearing surface extending between the upper end and the lower end with an upper ramp section, and a lower ramp section. A resting platform extends between a bottom end of the upper ramp section and a top end of the lower ramp section at an angle wherein the resting platform slopes opposite a slope of the upper ramp section and the lower ramp section when the ramp is extended between the lower surface and the elevated surface, whereby the resting platform is configured to receive a rear wheel of a motorcycle and prevent unwanted downward and rearward motion of the rear wheel along the motorcycle-bearing surface.

Although the disclosed implementations are discussed herein in light of their ability to be used by a single individual to load or unload a motorcycle to or from an elevated surface, it should be understood that the implementations can also be used by multiple people. Indeed, the implementations provide many advantages over existing ramps even when used by multiple people, as the ramp resists backward and downward motion caused by the weight of the motorcycle due to the resting platform or similar structure. It is also anticipated that use by two or more persons will further improve safety of use of the various implementations discussed herein. The various implementations of the invention will be illustrated in more detail below with respect to the attached Figures, which are explicitly incorporated herein by reference.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of an embodiment of a motorcycle ramp;

FIG. 2 shows an alternate perspective view of the embodiment of FIG. 1;

FIG. 3 shows an alternate perspective view of the embodiment of FIG. 1;

FIG. 4 shows an alternate perspective view of the embodiment of FIG. 1;

FIG. 5 shows an alternate perspective view of the embodiment of FIG. 1;

FIG. 6 shows an alternate perspective view of the embodiment of FIG. 1;

FIG. 7 shows a perspective view of an alternate embodiment of a motorcycle ramp;

FIG. 8 shows a perspective view of an alternate embodiment of a motorcycle ramp;

FIG. 9 shows a closer perspective view of the embodiment of FIG. 8; and

FIG. 10 shows a series of perspective views of how to use one embodiment of a motorcycle ramp.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

As embodiments of the invention relate to motorcycle ramps that permit a single individual to safely and easily load a motorcycle onto an elevated surface, the directions “downward,” “backward,” “rearward” or any combination thereof when referring to motion of a motorcycle on the various embodiments of the disclosed ramp shall be interpreted to mean in a direction descending the ramp (e.g. in a direction toward a lower surface from the elevated surface).

Embodiments of the present invention provide motorcycle ramps that permit a single individual to safely and easily load a motorcycle onto an elevated surface and to safely and easily unload the motorcycle from the elevated surface without assistance of a second individual (although assistance of a second individual may be used for further-increased safety). The motorcycle ramp includes a structure that receives and secures a rear wheel of the motorcycle, thereby preventing gravity from causing the motorcycle to roll uncontrolled down the ramp. The structure serves as a resting platform for the rear wheel of the motorcycle as the motorcycle is moved up or down the ramp. When the rear wheel is secured by the structure or resting on the structure, the person pushing the motorcycle up or down the ramp is more easily able to climb to and from the elevated surface, as the individual only needs to steady the motorcycle against side-to-side motion and needs not worry about backward motion down the ramp caused by gravity. The person is commonly able to prevent unwanted side-to-side motion using a single hand, freeing the person's other hand to assist in climbing up to or down from the elevated surface.

Motorcycle ramps in accordance with embodiments of the invention may be manufactured using a variety of materials and techniques, and may include foldable, telescopic or other elements to provide for compact storage and transportation of the motorcycle ramps. The structure that receives the rear wheel or resting platform is one of a variety of structures that can be adapted to the ramp. In some embodiments, a fixed structure provides the resting platform, such as a jog in the ramp or an elevated structure attached atop an otherwise linear ramp. In other embodiments, a movable structure provides the resting platform, and the moveable structure may be spring-loaded or otherwise biased into a position to provide the resting platform. The movable structure can be automatically or manually selectively actuated to allow passage of the motorcycle front and/or rear wheel as desired. In still other embodiments, the structure is a discontinuity in a motorcycle-bearing surface of the motorcycle ramp.

Thus, some embodiments of the invention provide a motorcycle ramp that permits a single individual to safely load and unload a motorcycle to and from an elevated surface. The motorcycle ramp of such embodiments includes an upper end configured to attach to or rest on a portion of an elevated surface, a lower end configured to rest on a lower surface, and a motorcycle-bearing surface extending between the upper end and the lower end. The motorcycle ramp also includes a resting structure configured to receive a rear wheel of a motorcycle and prevent unwanted downward and rearward motion of the rear wheel along the motorcycle-bearing surface, the resting structure being located in between the upper end and the lower end.

In some embodiments, the resting structure is formed from a jog in the motorcycle-bearing surface, which may be continuous or discontinuous. If the motorcycle-bearing surface is discontinuous, the motorcycle-bearing surface may be formed from a plurality of struts extending between side rails of the motorcycle ramp. The motorcycle-bearing surface may include an upper ramp section and a lower ramp section. In embodiments with a jog, the upper ramp section and the lower ramp section are not coplanar, although they may be parallel to each other. The motorcycle ramp may be foldable or may be separable or otherwise capable of disassembly into more than one piece.

In some embodiments, the resting platform or other resting structure includes an elevated or raised structure that is elevated above the motorcycle-bearing surface. The elevated or raised structure may be stationary or movable.

In various embodiments, the motorcycle ramp may have a length between approximately half the length of a motorcycle and approximately twice the length of the motorcycle. The distance between the upper end and the resting platform or other resting structure in such embodiments may range between approximately half the length of the motorcycle and approximately the length of the motorcycle. The distance between the lower end and the resting platform or other resting structure may be similar.

Further embodiments provide a motorcycle ramp having an upper end configured to attach to or rest on a portion of an elevated surface, a lower end configured to rest on a lower surface, and a motorcycle-bearing surface extending between the upper end and the lower end. A resting platform extends between an upper ramp section of the motorcycle-bearing surface and a lower ramp section of the motorcycle-bearing surface at an angle wherein the resting platform slopes opposite a slope of the motorcycle-bearing surface when the ramp is extended between the lower surface and the elevated surface.

Further embodiments provide a motorcycle ramp having an upper end configured to attach to or rest on a portion of an elevated surface, a lower end configured to rest on a lower surface, and a motorcycle-bearing surface extending between the upper end and the lower end with an upper ramp section, and a lower ramp section. A resting platform extends between a bottom end of the upper ramp section and a top end of the lower ramp section at an angle wherein the resting platform slopes opposite a slope of the upper ramp section and the lower ramp section when the ramp is extended between the lower surface and the elevated surface, whereby the resting platform is configured to receive a rear wheel of a motorcycle and prevent unwanted downward and rearward motion of the rear wheel along the motorcycle-bearing surface.

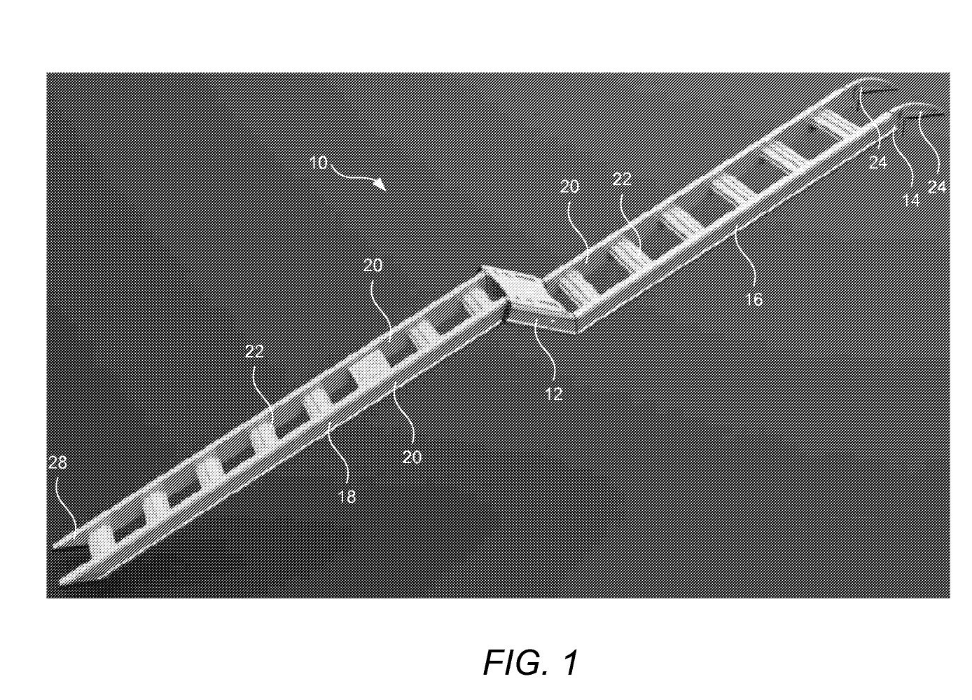

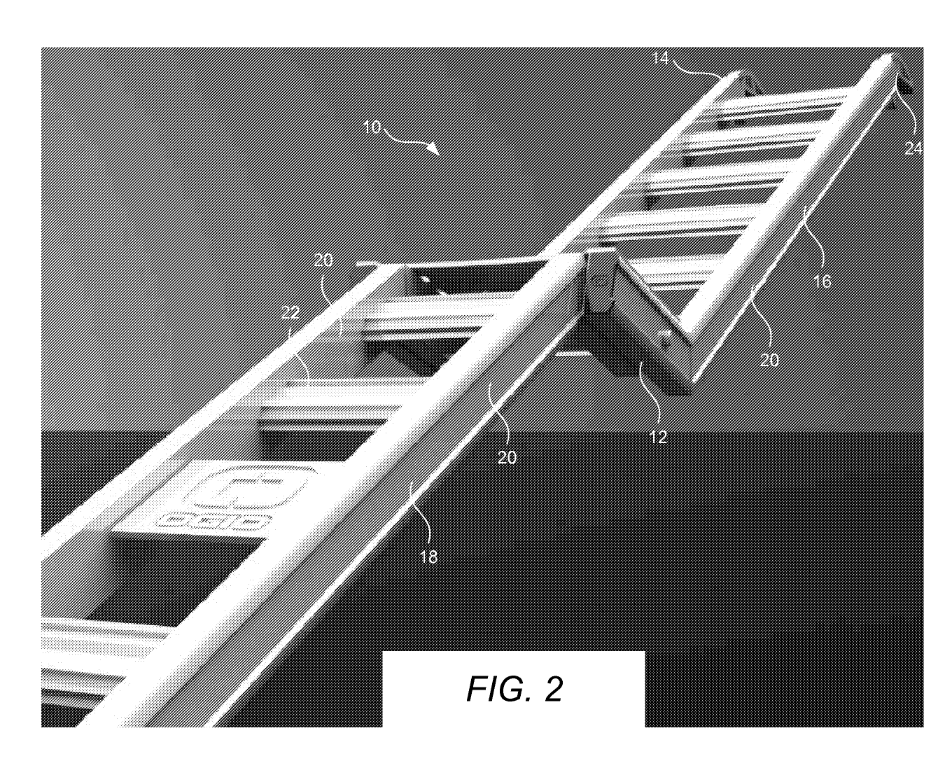

FIGS. 1-6 show perspective views of one embodiment of a motorcycle ramp 10 that is illustrative of features of the present invention. The ramp 10 includes a resting platform 12 located along the ramp 10. In this embodiment, the resting platform 12 represents a jog in the otherwise approximately linear course of the ramp 10. In the illustrated embodiment, the resting platform 12 or jog in the ramp 10 is located at an approximate midpoint of the ramp 10. The resting platform 12 or jog may be located at other points of the ramp 10 that need not be approximate midpoints of the ramp 10. The location of the resting platform 12 or jog may be determined by way of a wide variety of factors, including the total desired elevation gain to be provided by the ramp 10 and the total length of the ramp 10. As may be appreciated, the total length of the ramp 10 and the elevation gain to be provided by the ramp govern the approximate angle of inclination to be provided by the ramp in use.

By way of example and illustration of one embodiment only, the total length of the ramp 10 illustrated in FIGS. 1-6 may be between approximately one motorcycle length and approximately two motorcycle lengths, and the resting platform 12 in such embodiments may be located so that when a rear wheel of a desired or representative motorcycle is resting on the resting platform 12, the front wheel of the motorcycle is on the elevated surface (such as a truck bed) at the top of the ramp 10 and handlebars of the motorcycle are positioned roughly above an upper end 14 of the ramp 10. Thus, in such an embodiment, the distance between the upper end 14 and the resting platform 12 is between approximately half the length of the motorcycle and approximately the length of the motorcycle. As the length of various motorcycles is greatly variable, and as the heights to be achieved using the various embodiments also varies, it will be understood that the lengths of the ramp 10 and the various sections thereof discussed herein may be highly variable from embodiment to embodiment.

Such a selection of the length of the ramp 10 and placement of the resting platform 12 enable a person pushing the motorcycle up the ramp 10 to push the motorcycle up the ramp 10 until the rear wheel comes to rest on the resting platform 12, where the resting platform 12 substantially secures the rear wheel against undesired rearward or downward movement back down the ramp 10. In some embodiments, the front wheel of the motorcycle will then be on the elevated surface and therefore does not significantly contribute to any rearward forces imparted by the weight of the motorcycle and/or further assists in preventing undesired rearward movement.

Meanwhile, as the handlebars of the motorcycle are located near the top of the ramp 10 in this position, the location of the resting platform 12 has been selected so that the person pushing the motorcycle up the ramp 10 will not need to overextend him or herself to push to this point. Additionally, as the handlebars are located near the top of the ramp 10, the handlebars are advantageously located close to the edge of the elevated surface (such as at the edge of a tailgate of a pickup truck bed), minimizing any distance that the person is required to reach and/or stretch while he or she climbs up to the elevated surface to finish pushing the motorcycle up the ramp 10 onto the elevated surface. Similar advantages are obtained when pushing the motorcycle down the ramp 10 (e.g. the motorcycle is secured against undesirable rearward movement while the person descends from the elevated surface to a lower surface.

As embodiments of the motorcycle ramp 10 secure the motorcycle against unwanted rearward movement, the person using the ramp 10 need only steady the motorcycle against unwanted or excessive side-to-side motions. When the motorcycle is near-vertical, the total force of such side-to-side movements is very small when compared to the downward or rearward force applied to the motorcycle by gravity and that the person would have to push against were the resting platform 12 (or other similar resting structure) not present. Therefore, the person using the ramp 10 is much more easily able to hold and steady the motorcycle while ascending to the elevated surface from the lower surface, or while descending from the elevated surface to the lower surface.

As may be appreciated from FIGS. 1, 2, and 6, the resting platform 12 is provided at an angle to the remainder of the ramp 10. The angle of the resting platform 12 is selected in this embodiment so that the resting platform 12 provides a surface that is horizontal to sloping downward in the direction of the elevated surface (e.g. opposedly-angled with respect to the remainder of the ramp 10 in use), thereby providing a surface where the rear wheel of the motorcycle will naturally rest without tending to roll backward. This horizontal to downward sloping of the resting platform 12 is maintained in this embodiment over a variety of elevations of the elevated surface, but it will be appreciated that if the ramp 10 were to be used with an elevated surface that is too high, the illustrated resting platform 12 would be sloped the other direction, or away from the elevated surface, and would not act sufficiently to prevent the motorcycle from rolling backward down the ramp 10 under the influence of gravity.

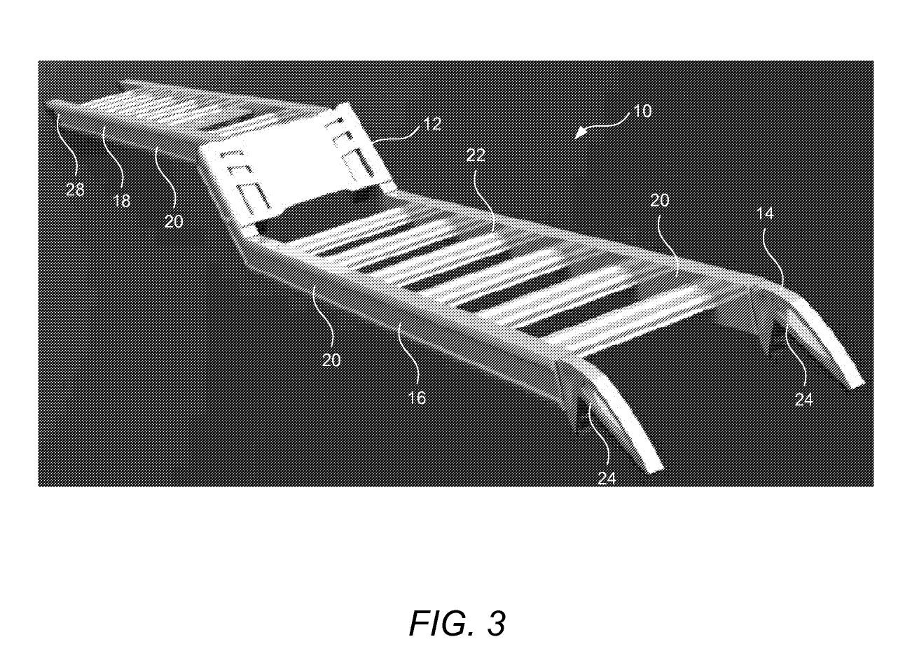

For this reason, at least some embodiments of the ramp 10 are provided with a more-significantly sloped resting platform 12 than the embodiment illustrated in FIGS. 1-6. In such embodiments, the jog made by the resting platform 12 may be more pronounced than the jog illustrated in FIG. 3, and the angle of the jog is therefore greater, whereby the resting platform 12 is closer to perpendicular to the remainder of the ramp 10. In some embodiments, the angle between the resting platform 12 and the remainder of the ramp 10 may be user-selectable or user-adjustable, thereby permitting use of the ramp 10 to load the motorcycle on varying heights of elevated surfaces beyond what is maximally convenient with certain particular fixed angles of the resting platform 12. Additionally, a less-perpendicular angle of the jog on some adjustable embodiments makes it easier to move the motorcycle up and down the ramp 10 to a lower elevated surface. In other words, a less-perpendicular angle of the jog allows the motorcycle wheels to more-easily pass over the jog at times where it is desirable to allow the wheels to pass over the jog. In at least some adjustable embodiments, the length of the resting platform 12 may also be variable to ensure that the rear wheel finds a secure place to rest on the resting platform 12.

Above the resting platform 12, the ramp 10 includes an upper ramp section 16, while below the resting platform 12, the ramp 10 includes a lower ramp section 18. The upper ramp section 16 and the lower ramp section 18 may be approximately equal in length, or one of the upper ramp section 16 and the lower ramp section 18 may be longer than the other section. The lower ramp section 18 is longer than the length of a representative motorcycle in some embodiments, but is commonly between approximately one-half to approximately one length of a representative motorcycle in length. The upper ramp section 16 is commonly shorter than the wheelbase of a representative motorcycle (the wheelbase being defined as the distance between the respective points of contact of the motorcycle's front and rear wheels with the ground), although it may be longer in some instances. A length of the upper ramp section 16 shorter than or close to (if longer than) the wheelbase of the motorcycle ensures that when the rear wheel of the motorcycle is on the resting platform 12, the handlebars or other structure of the motorcycle are close to the elevated surface so a single person can climb up to or down from the elevated surface while holding the motorcycle against sideways motion.

In some embodiments, one or both of the upper ramp section 16 and the lower ramp section 18 may be adjustable. As one example of adjustability, the adjustable ramp section may be telescopic, permitting the ramp 10 to be used to load/unload the motorcycle to/from a wide variety of heights of elevated surfaces while maintaining or approximately maintaining the angle of inclination of the ramp 10. If an adjustable ramp section is provided that is telescopic, it may be provided with a locking mechanism, such as are well known in the art of ladders or other telescopic devices such as tripods to lock the adjustable ramp section in one of a variety of set positions or at any desired position. Such locking mechanisms include, for example, locking pins, tabs, friction clamps, spring-biased locks, and the like.

As may be seen in FIGS. 1-6, the illustrated embodiment includes upper ramp section 16 and lower ramp section 18 being constructed in a ladder-like fashion, having side frames or side rails 20 and a number of spars, rungs, or struts 22 between the side frames or side rails 20. This type of construction is lightweight and the wheels of the motorcycle roll over the gaps between the spars, rungs, or struts 22 without significant resistance, as the spacing is significantly less than the diameter of the motorcycle's wheels. The spars, rungs, or struts 22 provide a discontinuous motorcycle-bearing surface of the ramp 10, and are one example of a motorcycle-bearing surface.

The side rails 20 keep the wheels of the motorcycle on the ramp 10, so they do not fall off the side of the ramp 10. However, the entire ramp 10 or motorcycle-bearing surface of the ramp 10 may be solid, continuous, and/or substantially-solid or substantially-continuous without adversely affecting the performance of the ramp 10. The ramp 10 merely needs to be strong enough to support the weight of the motorcycle (plus any desired safety factor) without buckling, and many types of construction may be used to satisfy this need other than the particular construction illustrated.

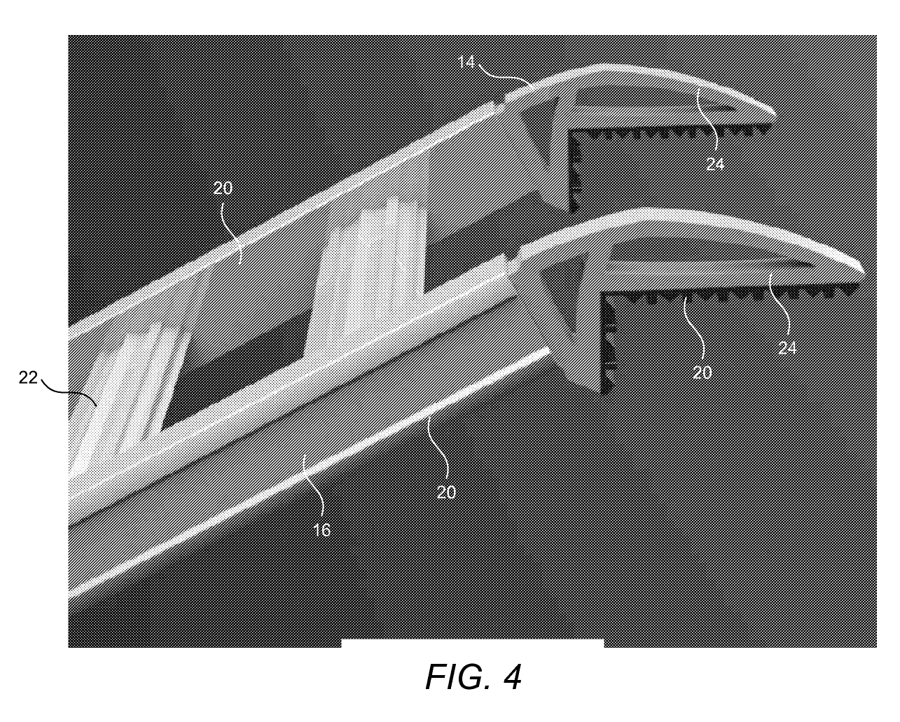

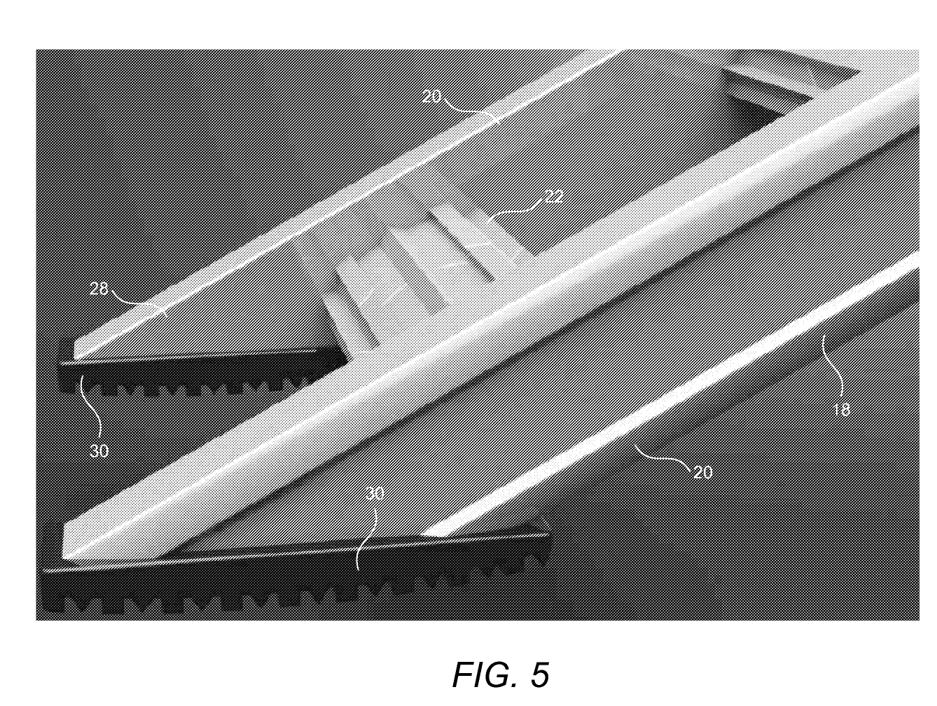

The ramp 10 may optionally be provided with features that ease use of the ramp 10. For example, as is particularly visible in FIG. 4, the upper end 14 of the upper ramp section 16 may include an attachment lip 24 to better secure the ramp 10 on the elevated surface. The attachment lip 24 may be formed as illustrated to engage the ramp 10 against a corner of the elevated surface to resist unwanted motion of the ramp 10 as the motorcycle is pushed up the ramp 10. Additionally, the attachment lip 24 may include a frictional surface 26 to further resist unwanted motion of the ramp 10 as the ramp 10 is used. Similarly, as shown in FIG. 5, a lower end 28 of the lower ramp section 18 may include a further frictional surface 30 to prevent or minimize slippage of the ramp 10 during use.

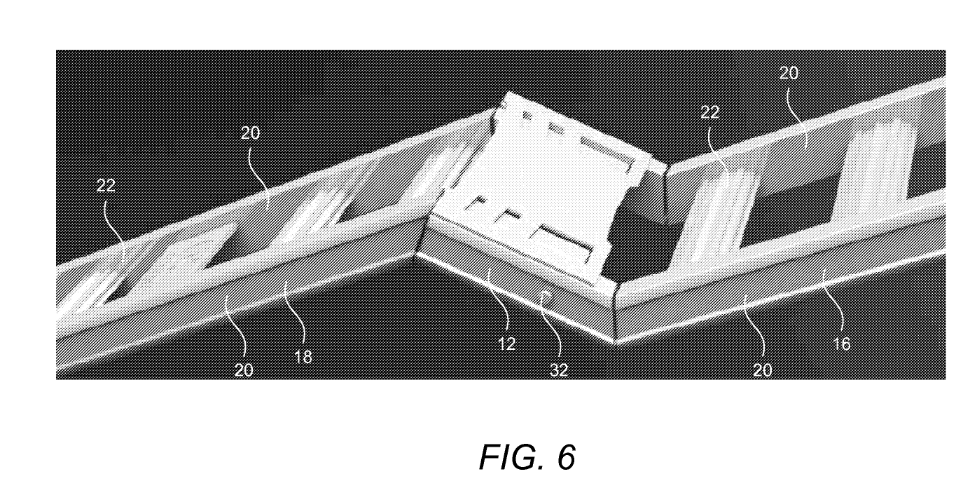

In some embodiments, it may be desirable for the ramp 10 to fold or otherwise become more compact for storage or transportation purposes. As discussed above, the upper ramp section 16 and/or the lower ramp section 18 may be made telescopic, which may make the ramp 10 sufficiently compact for storage when the telescoping ramp section or sections is in its most compact position. In other embodiments, the ramp 10 is foldable, such as at or near the resting platform 6. Such embodiments may be illustrated in more detail with respect to FIG. 6.

In FIG. 6, it is shown that the resting platform 12 includes a release 32. The release 32 serves to allow the user of the ramp 10 to release the ramp 10 from a locked state to permit folding or other adjustment. The ramp 10 then may be foldable about one or more hinges (not shown) or some other folding mechanism so that the upper ramp section 16 is substantially adjacent the lower ramp section 18, whereupon the total length of the folded ramp 10 is significantly shorter than the total length of the unfolded ramp 10 (e.g. approximately half the total length of the unfolded ramp 10 when the upper ramp section 16 and the lower ramp section 18 are of approximately the same length).

In still other embodiments, the ramp 10 may be provided in various sections that may be attached to and detached from one another. For example, the resting platform 12 may be provided separately from the upper ramp section 16 and the lower ramp section 18, and be attached to those sections to form the complete ramp 10 during use, and then detached from those sections for storage or transportation. Alternatively, the resting platform 12 may be permanently attached to one of the upper ramp section 16 and the lower ramp section 18, and the other section is reversibly attachable to the resting platform 12. Any method for permanent/reversible attachment, as applicable, may be used for such attachment between sections. The above-described mechanisms for making the ramp 10 more compact for storage and/or transportation are intended to be merely illustrative, and other mechanisms known in the art or later-created may also be used.

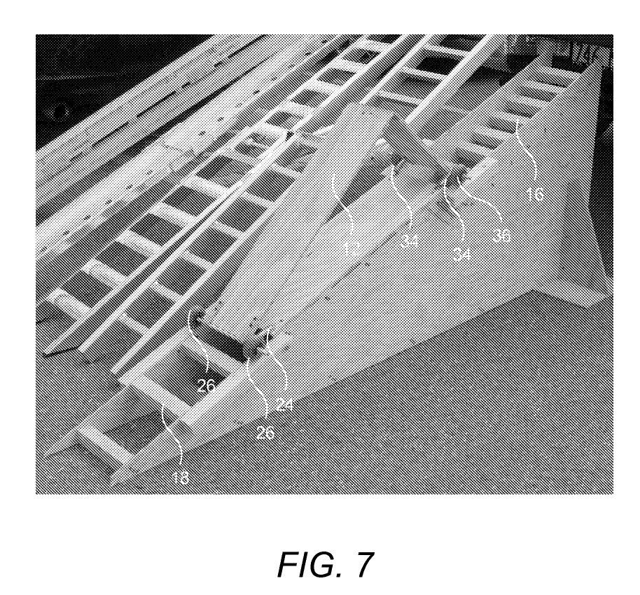

Although features of some embodiments of the invention have been described above, it is envisioned that the invention may take many forms other than those specifically described above and illustrated with respect to FIGS. 1-6. For example, alternative embodiments are shown in FIGS. 7-9. In such embodiments, the upper ramp section 16 and the lower ramp section 18 are or may be substantially-coplanar. In other words, there is no jog between those sections. Instead, the resting platform 12 is provided as a raised structure in such a way so as to extend upward above an upper motorcycle-bearing surface of the upper ramp section 16 and the lower ramp section 18.

In the embodiment shown in FIG. 7, the resting platform 12 is provided as a moveable mechanism that is spring-loaded or otherwise-biased to normally be in a position that provides the resting platform 12. This specific embodiment includes one or more springs 34 which are attached between the underlying ramp 10 and the resting platform 12. The springs 34 are attached to the resting platform 12 proximate rollers 36 of the resting platform 12. The resting platform 12 is hinged in the middle, so that if a downward force is applied near the center of the resting platform 12, the center of the resting platform 12 will move downward, stretching the springs 34 as the rollers 36 roll up and down the ramp 10. This flattens the resting platform 12 until the weight is removed from the center of the resting platform 12.

This embodiment functions as the resting platform 12 moves as the motorcycle is passed over the resting platform 12. As the wheel of the motorcycle is pushed up the resting platform 12, it pushes downward on the resting platform 12, causing the resting platform 12 to flatten out. As the rear wheel of the motorcycle passes to near the top of the resting platform 12, the downward pressure on the resting platform 12 is released, and the tension in the springs 34 causes the resting platform 12 to resume the position shown in FIG. 7, whereupon it can secure the rear wheel against downward motion back down the ramp 10 that would otherwise be possible under the influence of gravity. The user is able to push the motorcycle downward so the rear wheel rides up on the raised resting platform 12, but the backward force due to gravity alone is insufficient to actuate the resting platform 12, so the motorcycle is secured against unwanted rearward movement.

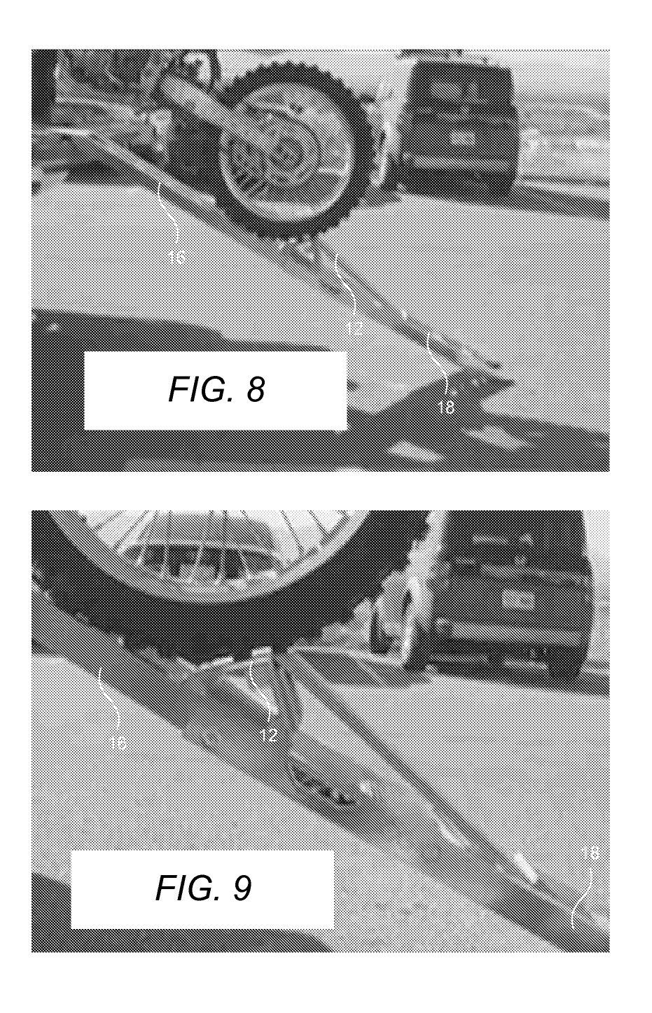

In the embodiment of FIGS. 8 and 9, the resting platform 12 is a fixed structure that extends upward above the remaining motorcycle-bearing surface of the ramp 10. A lower portion of the resting platform 12 is inclined at a steeper angle than the remainder of the ramp 10, and the motorcycle wheel rolls up over this portion as the motorcycle is pushed up the ramp 10. The peak of the resting platform 12 then secures the rear wheel against unwanted rearward motion of the motorcycle, while the user can selectively push the motorcycle back down the ramp 10, over the peak of the resting platform 12.

In the embodiments illustrated by FIGS. 1-6, the upper ramp section 16 is not coplanar with the lower ramp section 18; the jog of the resting platform 12 separates the planes formed by these sections. The upper ramp section 16 and the lower ramp section 18 may be substantially parallel to each other, however. In contrast, in the embodiments illustrated by FIGS. 7-9, the upper ramp section 16 and the lower ramp section may be substantially coplanar, as the resting structure (e.g. the resting platform 12) in such embodiments is a raised or elevated structure extending above the motorcycle-bearing surface of the ramp 10.

Another type of embodiment that may have substantially-coplanar upper and lower ramp sections is one in which the resting structure is a discontinuity of the motorcycle-bearing surface (e.g. a hole) that is large enough to receive the motorcycle's back wheel and prevent unwanted rearward movement of the motorcycle. In some embodiments, the discontinuity may be a selectively-openable discontinuity. Therefore, for example, a hinged plate or other structure may normally fill the discontinuity. However, as the front wheel of the motorcycle passes up the ramp 10 past the covered discontinuity, it actuates a trigger that releases the hinged plate or otherwise uncovers the discontinuity, such that the rear wheel enters into the discontinuity, thereby preventing unwanted rearward movement of the motorcycle.

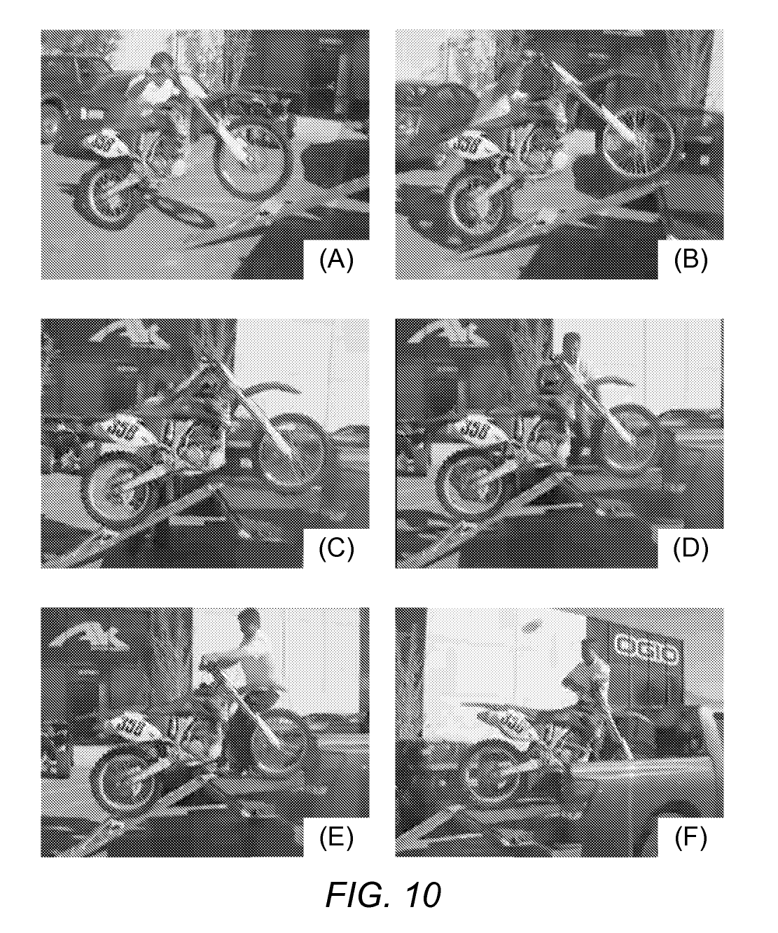

FIG. 10 provides a series of views of a motorcycle being pushed up an embodiment of the motorcycle ramp 10, illustrating how the ramp 10 is used and functions. The user begins pushing the motorcycle up the ramp 10 at (A). The user can begin pushing from well back of the ramp 10 if desired to gain momentum for easing the climb up the ramp. As is shown at (A), the front wheel passes over the resting platform 12 and the user continues to push the motorcycle up the ramp at (B), until the rear wheel of the motorcycle passes over the resting platform 12 at (C). At this point, the motorcycle may be allowed to roll back slightly, if necessary, until the rear wheel is secured against unwanted rearward movement (caused by gravity) by the resting platform 12. As may be seen, the handlebars of the motorcycle are then positioned near and above the upper end of the ramp 10 and the corresponding edge of the elevated surface, a truck bed in this instance.

The user is therefore easily able to hold the motorcycle handlebars with one hand while using the other hand to climb up onto the elevated surface at (D). Thus, as the user climbs up onto the elevated surface, he or she only needs to balance the motorcycle against unwanted side-to-side motion, and not against unwanted rearward motion. The user then finishes pulling the motorcycle up onto the elevated surface at (E) until the motorcycle is entirely on the elevated surface at (F) and is no longer on the ramp 10.

To descend from the elevated surface, the process is essentially reversed, with the user utilizing the hand brakes of the motorcycle as the motorcycle begins to descend the ramp 10 at (E). The hand brakes allow the user to ease the motorcycle down the ramp 10 until the rear wheel is stopped by the resting platform 12, whereupon the user descends from the elevated surface at (D). The user can then pull the motorcycle over the bump of the resting platform 12 and down the remainder of the ramp 10, continuing to use the hand brakes as desired or needed.

Thus, the ramp 10, in its various embodiments, permits a single person to safely and easily raise or lower a motorcycle to or from an elevated surface. Where a second person is available to assist, safety is further enhanced, as discussed herein. Regardless, this single-person use is achieved without requiring a ramp wide enough for the user to stand on/walk up with the motorcycle. The ramp 10 and its components may be manufactured from or include a wide variety of materials for structural, weight, and/or decorative reasons, including metals such as aluminum alloys, carbon fiber or other composite materials, fiberglass, wood, and plastics. The foregoing list of materials is intended to be illustrative and not limiting.

Furthermore, several embodiments of the resting platform 12 have been described, but it is anticipated that a variety of structures may be utilized to secure the rear wheel of the motorcycle against unwanted rearward movement and may therefore serve as the resting platform 12, including a gap or other discontinuity in the motorcycle-bearing surface of the ramp 10, as described above. While embodiments have been described that include substantially-linear or approximately-linear (e.g. straight) upper ramp sections 14 and lower ramp sections 16 (or motorcycle-bearing surfaces thereof), other embodiments may have an upper ramp section 16 and/or a lower ramp section 18 having a curved profile or motorcycle-bearing surface.

While use of the ramp 10 has been disclosed as enabling use by a single person, it is anticipated that safety of use of the ramp will still be greater when two or more people are available to assist with loading and unloading of the motorcycle using the ramp 10. The ramp 10 still provides advantages over existing ramps for use by multiple people, as the resting platform 12 or similar structure provides a natural stop point along the ramp, where the motorcycle is secured against rolling backward due to gravity, and may be more easily passed from one person (e.g. below) to the next (e.g. above, on the elevated surface) without having to be constantly pushed forward against rolling backward. Additionally or alternatively, some individuals may find it advantageous to utilize or provide an intermediate step-up location alongside the ramp 10 to assist in reaching the point where the rear wheel of the motorcycle is secured by the resting platform 12 or similar structure. For example, this may be particularly advantageous for shorter users who may otherwise find it more difficult to reach up and maintain a grip on the handlebars.

While the use of the ramp 10 has been described herein with the resting platform 12 or other resting structure engaging and holding the rear wheel of the motorcycle, it is anticipated that the ramp 10 may also be used to catch and secure the front wheel of the motorcycle. By way of example only, some users may find it more convenient when unloading the motorcycle from the elevated surface to push the motorcycle down the ramp 10 front wheel first, and the ramp 10 and resting platform 12 performs the functions described herein equally well regardless of which wheel is secured by the resting platform 12.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A motorcycle ramp that permits a single individual to safely load and unload a motorcycle to and from an elevated surface, the motorcycle ramp comprising:
an upper end configured to attach to or rest on a portion of an elevated surface;
a lower end configured to rest on a lower surface;
a motorcycle-bearing surface extending between the upper end and the lower end; and
a resting structure configured to receive a rear wheel of a motorcycle and prevent unwanted downward and rearward motion of the rear wheel along the motorcycle-bearing surface, the resting structure being located in between the upper end and the lower end.

2. A motorcycle ramp as recited in claim 1, wherein the resting structure comprises a jog in the motorcycle-bearing surface.

3. A motorcycle ramp as recited in claim 2, wherein the motorcycle-bearing surface comprises:
an upper ramp section between the upper end and the resting structure; and
a lower ramp section between the lower end and the resting structure.

4. A motorcycle ramp as recited in claim 3, wherein the motorcycle-bearing surface of the upper ramp section is not coplanar with the motorcycle-bearing surface of the lower ramp section.

5. A motorcycle ramp as recited in claim 4, wherein the motorcycle ramp is foldable at a location proximate the resting structure.

6. A motorcycle ramp as recited in claim 3, wherein the upper ramp section and the lower ramp section each comprise a pair of lengthwise side rails having horizontal struts extending therebetween to form the motorcycle-bearing surface.

7. A motorcycle ramp as recited in claim 1, wherein the resting structure comprises a raised structure that is elevated above the motorcycle-bearing surface.

8. A motorcycle ramp as recited in claim 7, wherein the ramp comprises:
an upper ramp section between the upper end and the resting structure; and
a lower ramp section between the lower end and the resting structure.

9. A motorcycle ramp as recited in claim 8, wherein the motorcycle-bearing surface of the upper ramp section and the motorcycle-bearing surface of the lower ramp section are substantially coplanar.

10. A motorcycle ramp as recited in claim 1, wherein the motorcycle ramp is foldable at a location proximate the resting structure.

11. A motorcycle ramp as recited in claim 1, wherein the motorcycle ramp comprises two or more pieces that can be disassembled for more-compact storage and transport.

12. A motorcycle ramp as recited in claim 1, wherein the resting structure comprises a moveable element that moves as a motorcycle wheel passes over it and that returns to a rear-wheel engaging position after the rear wheel passes over it.

13. A motorcycle ramp as recited in claim 1, wherein the resting structure comprises a opposedly-angled portion of the motorcycle-bearing surface.

14. A motorcycle ramp as recited in claim 1, wherein the motorcycle-bearing surface is discontinuous.

15. A motorcycle ramp that permits a single individual to safely load and unload a motorcycle to and from an elevated surface, the motorcycle ramp comprising:
an upper end configured to attach to or rest on a portion of an elevated surface;
a lower end configured to rest on a lower surface;
a motorcycle-bearing surface extending between the upper end and the lower end; and
a resting platform extending between an upper ramp section of the motorcycle-bearing surface and a lower ramp section of the motorcycle-bearing surface at an angle wherein the resting platform slopes opposite a slope of the motorcycle-bearing surface when the ramp is extended between the lower surface and the elevated surface.

16. A motorcycle ramp as recited in claim 15, wherein the resting platform is configured to receive a rear wheel of a motorcycle and prevent unwanted downward and rearward motion of the rear wheel along the motorcycle-bearing surface, the resting platform being located in between the upper end and the lower end.

17. A motorcycle ramp as recited in claim 15, wherein the motorcycle ramp has a length of between approximately half the length of the motorcycle and approximately twice the length of the motorcycle.

18. A motorcycle ramp as recited in claim 17, wherein a distance between the upper end and the resting platform is between approximately half the length of the motorcycle and approximately the length of the motorcycle.

19. A motorcycle ramp as recited in claim 15, wherein the motorcycle ramp is foldable at a location proximate the resting platform.

20. A motorcycle ramp that permits a single individual to safely load and unload a motorcycle to and from an elevated surface, the motorcycle ramp comprising:
an upper end configured to attach to or rest on a portion of an elevated surface;
a lower end configured to rest on a lower surface;
a motorcycle-bearing surface extending between the upper end and the lower end and comprising:
an upper ramp section; and
a lower ramp section; and
a resting platform extending between a bottom end of the upper ramp section and a top end of the lower ramp section at an angle wherein the resting platform slopes opposite a slope of the upper ramp section and the lower ramp section when the ramp is extended between the lower surface and the elevated surface, wherein the resting platform is configured to receive a rear wheel of a motorcycle and prevent unwanted downward and rearward motion of the rear wheel along the motorcycle-bearing surface.
